(19) United States
(12) Patent Application Publication
(10) Pub. No.: US 2015/0253864 A1
(43) Pub. Date: Sep. 10, 2015

(54) Image Processor Comprising Gesture Recognition System with Finger Detection and Tracking Functionality

(71) Applicant: Avago Technologies General IP (Singapore) Pte. Ltd., Singapore (SG)

(72) Inventors: Denis Vladimirovich Parkhomenko, Mytyschy (RU); Ivan Leonidovich Mazurenko, Khimki (RU); Dmitry Nicolaevich Babin, Moscow (RU); Denis Vladimirovich Zaytsev, Dzerzhinsky (RU); Aleksey Alexandrovich Letunovskiy, Moscow (RU)

(21) Appl. No.: 14/640,519

(22) Filed: Mar. 6, 2015

(30) Foreign Application Priority Data
Mar. 6, 2014 (RU) 2014108820

(51) Int. Cl. G06F 3/01; G06K 9/00; G06K 9/46; G06F 3/03

(52) U.S. Cl. CPC G06F 3/017; G06F 3/0304; G06K 9/00355; G06K 9/4604

(57) ABSTRACT

An image processing system comprises an image processor having image processing circuitry and an associated memory. The image processor is configured to implement a gesture recognition system utilizing the image processing circuitry and the memory. The gesture recognition system comprises a finger detection and tracking module configured to identify a hand region of interest in a given image, to extract a contour of the hand region of interest, to detect fingertip positions using the extracted contour, and to track movement of the fingertip positions over multiple images including the given image.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system utilizing the image processing circuitry and the memory. The gesture recognition system comprises a finger detection and tracking module configured to identify a hand region of interest in a given image, to extract a contour of the hand region of interest, to detect fingertip positions using the extracted contour, and to track movement of the fingertip positions over multiple images including the given image.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a finger detection and tracking module in an illustrative embodiment.

FIG. 2 is a flow diagram of an exemplary process performed by the finger detection and tracking module in the image processor of FIG. 1.

FIG. 3 shows an example of a hand image and a corresponding extracted contour comprising an ordered list of points.

FIG. 4 illustrates tracking of fingertip positions over multiple frames.

FIG. 5 is a block diagram of another embodiment of a recognition subsystem suitable for use in the image processor of the FIG. 1 image processing system.

FIG. 6 shows an exemplary contour for a hand pose pattern with enumerated fingertip positions.

FIG. 7 illustrates application of a dynamic warping operation to determine point-to-point correspondence between the FIG. 6 hand pose pattern contour and another contour obtained from an input frame.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves detection and tracking of particular objects in one or more images. Accordingly, although described primarily in the context of finger detection and tracking for facilitation of gesture recognition, the disclosed techniques can be adapted in a straightforward manner for use in detection of a wide variety of other types of objects and in numerous applications other than gesture recognition.

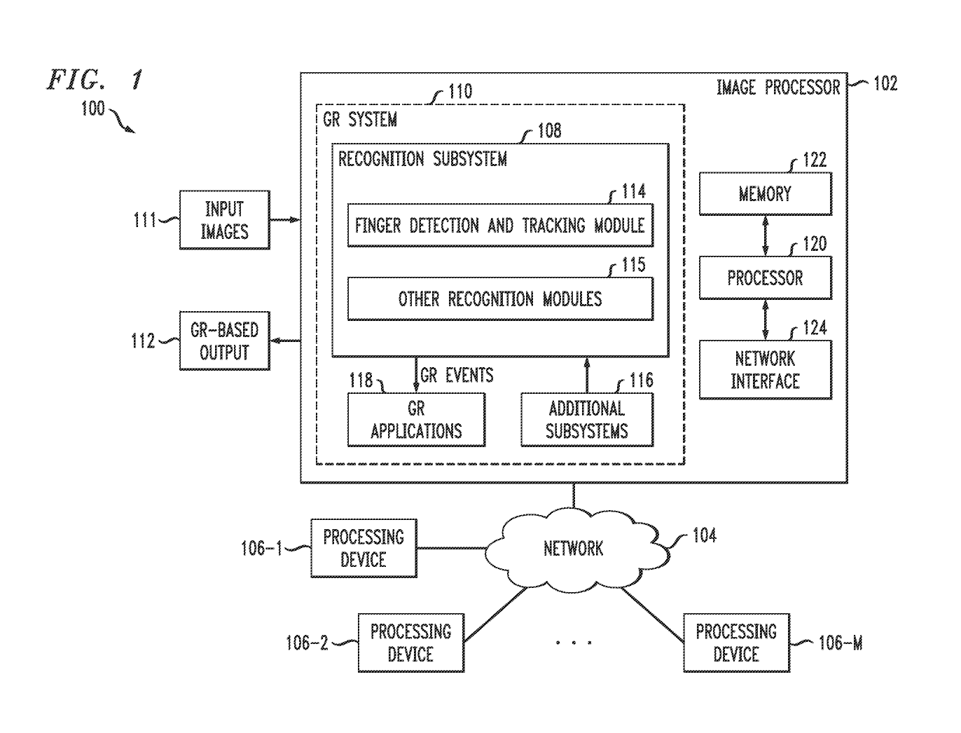

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 108 within a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

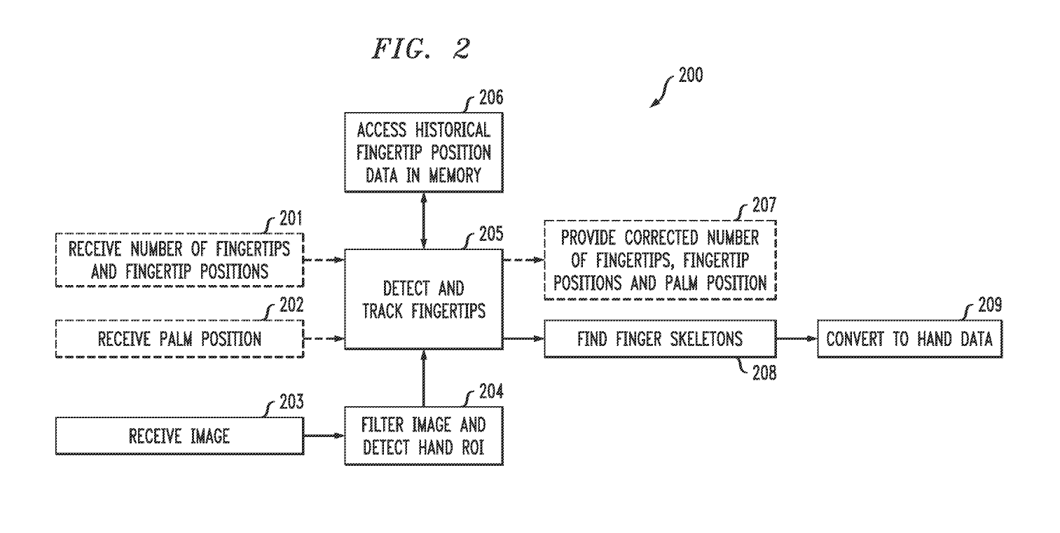

The recognition subsystem 108 of GR system 110 more particularly comprises a finger detection and tracking module 114 and one or more other recognition modules 115. The other recognition modules may comprise, for example, one or more of a static pose recognition module, a cursor gesture recognition module and a dynamic gesture recognition module, as well as additional or alternative modules. The operation of illustrative embodiments of the GR system 110 of image processor 102 will be described in greater detail below in conjunction with FIGS. 2 through 7.

The recognition subsystem 108 receives inputs from additional subsystems 116, which may comprise one or more image processing subsystems configured to implement functional blocks associated with gesture recognition in the GR system 110, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

It should be understood, however, that these particular functional blocks are exemplary only, and other embodiments of the invention can be configured using other arrangements of additional or alternative functional blocks.

In the FIG. 1 embodiment, the recognition subsystem 108 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 108 recognizes within the image a gesture from a specified gesture vocabulary and generates a corresponding gesture pattern identifier (ID) and possibly additional related parameters for delivery to one or more of the applications 118. The configuration of such information is adapted in accordance with the specific needs of the application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of the set of GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 110.

It should be noted, however, that embodiments of the invention are not limited to recognition of static or dynamic hand gestures, or cursor hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 108 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor or other type of image sensor, but other types of received image data may be processed in other embodiments. Such preprocessing operations may include noise reduction and background removal.

By way of example, the raw image data received by the GR system 110 from a depth sensor may include a stream of frames comprising respective depth images, with each such depth image comprising a plurality of depth image pixels. A given depth image may be provided to the GR system 110 in the form of a matrix of real values, and is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 115, 116 and 118 of image processor 102. One possible example of image processing circuitry that may be used in one or more embodiments of the invention is an otherwise conventional graphics processor suitably reconfigured to perform functionality associated with one or more of the components 114, 115, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination. A “processor” as the term is generally used herein may therefore comprise portions or combinations of a microprocessor, ASIC, FPGA, CPU, ALU, DSP or other image processing circuitry.

The memory 122 stores software code for execution by the processor 120 in implementing portions of the functionality of image processor 102, such as the subsystems 108 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the GR system 110 of image processor 102 will now be described in greater detail with reference to the diagrams of FIGS. 2 through 7.

It is assumed in these embodiments that the input images 111 received in the image processor 102 from an image source comprise at least one of depth images and amplitude images. For example, the image source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels.

In some embodiments, the image sensor is configured to operate at a variable frame rate, such that the finger detection and tracking module 114 or at least portions thereof can operate at a lower frame rate than other recognition modules 115, such as recognition modules configured to recognize static pose, cursor gestures and dynamic gestures. However, use of variable frame rates is not a requirement, and a wide variety of other types of sources supporting fixed frame rates can be used in implementing a given embodiment.

Certain types of image sources suitable for use in embodiments of the invention are configured to provide both depth and amplitude images. It should therefore be understood that the term “depth image” as broadly utilized herein may in some embodiments encompass an associated amplitude image. Thus, a given depth image may comprise depth information as well as corresponding amplitude information. For example, the amplitude information may be in the form of a grayscale image or other type of intensity image that is generated by the same image sensor that generates the depth information. An amplitude image of this type may be considered part of the depth image itself, or may be implemented as a separate image that corresponds to or is otherwise associated with the depth image. Other types and arrangements of depth images comprising depth information and having associated amplitude information may be generated in other embodiments.

Accordingly, references herein to a given depth image should be understood to encompass, for example, an image that comprises depth information only, or an image that comprises a combination of depth and amplitude information. The depth and amplitude images mentioned previously therefore need not comprise separate images, but could instead comprise respective depth and amplitude portions of a single image. An “amplitude image” as that term is broadly used herein comprises amplitude information and possibly other types of information, and a “depth image” as that term is broadly used herein comprises depth information and possibly other types of information.

Referring now to FIG. 2, a process 200 performed by the finger detection and tracking module 114 in an illustrative embodiment is shown. The process is assumed to be applied to image frames received from a frame acquisition subsystem of the set of additional subsystems 116. The process 200 in the present embodiment does not require the use of preliminary denoising or other types of preprocessing and can work directly with raw image data from an image sensor. Alternatively, each image frame may be preprocessed in a preprocessing subsystem of the set of additional subsystems 116 prior to application of the process 200 to that image frame, as indicated previously. A given image frame is also referred to herein as an image or a frame, and those terms are intended to be broadly construed.

The process 200 as illustrated in FIG. 2 comprises steps 201 through 209. Steps 201, 202 and 207 are shown in dashed outline as such steps are considered optional in the present embodiment, although this notation should not be viewed as an indication that other steps are required in any particular embodiment. Each of the above-noted steps of the process 200 will be described in greater detail below. In other embodiments, certain steps may be combined with one another, or additional or alternative steps may be used.

In step 201, information indicating a number of fingertips and fingertip positions is received by the finger detection and tracking module 114. Such information may be available for some frames from other components of the recognition subsystem 108 and when available can be utilized enhance the quality and performance of the process 200 or to reduce its computational complexity. The fingertip position information may be approximate, such as rectangular bounds for each fingertip.

In step 202, information indicating palm position is received by the finger detection and tracking module 114. Again, such information may be available for some frames from other components of the recognition subsystem 108 and can be utilized enhance the quality and performance of the process 200 or to reduce its computational complexity. Like the fingertip position information, the palm position information may be approximate. For example, it need not provide an exact palm center position but may instead provide an approximate position of the palm center, such as rectangular bounds for the palm center.

The information referred to in steps 201 and 202 may be obtained based on a particular currently detected hand shape. For example, the system may store for all possible hand shapes detectable by the recognition subsystem 108 corresponding information for number of fingertips, fingertip positions and palm position.

In step 203, an image is received by the finger detection and tracking module 114. The received image is also referred to in subsequent description below as an “input image” or as simply an “image.” The image is assumed to correspond to a single frame in a sequence of image frames to be processed. As indicated above, the image may be in the form of an image comprising depth information, amplitude information or a combination of depth and amplitude information. The latter type of arrangement may illustratively comprise separate depth and amplitude images for a given image frame, or a single image that comprises both depth and amplitude information for the given image frame. Amplitude images as that term is broadly used herein should be understood to encompass luminance images or other types of intensity images. Typically, the process 200 produces better results using both depth and amplitude information than using only depth information or only amplitude information.

In step 204, the image is filtered and a hand region of interest (ROI) is detected in the filtered image. The filtering portion of this process step illustratively applies noise reduction filtering, possibly utilizing techniques such as those disclosed in PCT International Application PCT/US13/56937, filed on Aug. 28, 2013 and entitled “Image Processor With Edge-Preserving Noise Suppression Functionality,” which is commonly assigned herewith and incorporated by reference herein.

Detection of the ROI in step 204 more particularly involves defining an ROI mask for a region in the image that corresponds to a hand of a user in an imaged scene, also referred to as a “hand region.”

The output of the ROI detection step in the present embodiment more particularly includes an ROI mask for the hand region in the input image. The ROI mask can be in the form of an image having the same size as the input image, or a sub-image containing only those pixels that are part of the ROI.

For further description of process 200, it is assumed that the ROI mask is implemented as a binary ROI mask that is in the form of an image, also referred to herein as a “hand image,” in which pixels within the ROI are have a certain binary value, illustratively a logic 1 value, and pixels outside the ROI have the complementary binary value, illustratively a logic 0 value. The binary ROI mask may therefore be represented with 1-valued or “white” pixels identifying those pixels within the ROI, and 0-valued or “black” pixels identifying those pixels outside of the ROI. As indicated above, the ROI corresponds to a hand within the input image, and is therefore also referred to herein as a hand ROI.

It is also assumed that the binary ROI mask generated in step 204 is an image having the same size as the input image. Thus, by way of example, if the input image comprises a matrix of pixels with the matrix having dimension frame_width×frame_height, the binary ROI mask generated in step 204 also comprises a matrix of pixels with the matrix having dimension frame_width×frame_height.

At least one of depth values and amplitude values are associated with respective pixels of the ROI defined by the binary ROI mask. These ROI pixels are assumed to be part of the input image.

A variety of different techniques can be used to detect the ROI in step 204. For example, it is possible to use techniques such as those disclosed in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

As another example, the binary ROI mask can be determined using threshold logic applied to pixel values of the input image.

More particularly, in embodiments in which the input image comprises amplitude information, the ROI can be detected at least in part by selecting only those pixels with amplitude values greater than some predefined threshold. For active lighting imagers such as SL or ToF imagers or active lighting infrared imagers, the closer an object is to the imager, the higher the amplitude values of the corresponding image pixels, not taking into account reflecting materials. Accordingly, selecting only those pixels with relatively high amplitude values for the ROI allows one to preserve close objects from an imaged scene and to eliminate far objects from the imaged scene.

It should be noted that for SL or ToF imagers that provide both depth and amplitude information, pixels with lower amplitude values tend to have higher error in their corresponding depth values, and so removing pixels with low amplitude values from the ROI additionally protects one from using incorrect depth information.

In embodiments in which depth information is available in addition to or in place of amplitude information, the ROI can be detected at least in part by selecting only those pixels with depth values falling between predefined minimum and maximum threshold depths Dmin and Dmax. These thresholds are set to appropriate distances between which the hand region is expected to be located within the image. For example, the thresholds may be set as Dmin=0, Dmax=0.5 meters (m), although other values can be used.

In conjunction with detection of the ROI, opening or closing morphological operations utilizing erosion and dilation operators can be applied to remove dots and holes as well as other spatial noise in the image.

One possible implementation of a threshold-based ROI determination technique using both amplitude and depth thresholds is as follows:

1. Set ROIᵢⱼ=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

It is also possible in some embodiments to detect a palm boundary and to remove from the ROI any pixels below the palm boundary, leaving essentially only the palm and fingers in a modified hand image. Such a step advantageously eliminates, for example, any portions of the arm from the wrist to the elbow, as these portions can be highly variable due to the presence of items such as sleeves, wristwatches and bracelets, and in any event are typically not useful for hand gesture recognition.

Exemplary techniques suitable for use in implementing the above-noted palm boundary determination in the present embodiment are described in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

Alternative techniques can be used. For example, the palm boundary may be determined by taking into account that the typical length of the human hand is about 20-25 centimeters (cm), and removing from the ROI all pixels located farther than a 25 cm threshold distance from the uppermost fingertip, possibly along a determined main direction of the hand. The uppermost fingertip can be identified simply as the uppermost 1 value in the binary ROI mask.

It should be appreciated, however, that palm boundary detection need not be applied in determining the binary ROI mask in step 204.

The ROI detection in step 204 is facilitated using the palm position information from step 202 if available. For example, the ROI detection can be considerably simplified if approximate palm center coordinates are available from step 202.

Also, as object edges in depth images provided by SL or ToF cameras typically exhibit much higher noise levels than the object surface, additional operations may be applied in order to reduce or otherwise control such noise at the edges of the detected ROI. For example, binary erosion may be applied to eliminate near edge points within a specified neighborhood of ROI pixels, with S_{nhood}(N) denoting the size of an erosion structure element utilized for the N-th frame. An exemplary value is S_{nhood}(N)=3, but other values can be used. In some embodiments, S_{nhood}(N) is selected based on average distance to the hand in the image, or based on similar measures such as ROI size. Such morphological erosion of the ROI is combined in some embodiments with additional low-pass filtering of the depth image, such as 2D Gaussian smoothing or other types of low-pass filtering. If the input image does not comprise a depth image, such low-pass filtering can be eliminated.

In step 205, fingertips are detected and tracked. This process utilizes historical fingertip position data obtained by accessing memory in step 206 in order to find correspondence between fingertips in the current and previous frames. It can also utilize additional information such as number of fingertips and fingertip positions from step 201 if available. The operations performed in step 205 are assumed to be performed on the binary ROI mask previously determined for the current image in step 204.

The fingertip detection and tracking in the present embodiment is based on contour analysis of the binary ROI mask, denoted M, where M is a matrix of dimension frame_width×frame_height. Let m(i,j) be the mask value in the (i,j)-th pixel. Let D(M) be a distance transform for M and palm center coordinates (i₀,j₀)=argmax(D(M)). If argmax cannot be uniquely determined, one can instead choose a point that is closest to a centroid of the non-zero elements of M: {(i,j)|m(i,j)>0, 0<i<frame_width+1, 0<j<frame_height+1}. Other techniques may be used to determine palm center coordinates (i₀,j₀), such as finding the center of mass of the hand ROI or finding the center of the minimal bounding box of the eroded ROI.

If palm position information is available from step 202, that information can be used to facilitate the determination of the palm center coordinates, in order to reduce the computational complexity of the process 200. For example, if approximate palm center coordinates are available from step 202, this information can be used directly as the palm center coordinates (i₀,j₀), or as a starting point such that the argmax(D(M)) is determined only for a local neighborhood of the input palm center coordinates.

The palm center coordinates (i₀,j₀) are also referred to herein as simply the “palm center” and it should be understood that the latter term is intended to be broadly construed and may encompass any information providing an exact or approximate position of a palm center in a hand image or other image.

A contour C(M) of the hand ROI is determined and then simplified by excluding points which do not deviate significantly from the contour.

Determination of the contour of the hand ROI permits the contour to be used in place of the hand ROI in subsequent processing steps. By way of example, the contour is represented as ordered list of points characterizing the general shape of the hand ROI. The use of such a contour in place of the hand ROI itself provides substantially increased processing efficiency in terms of both computational and storage resources.

A given extracted contour determined in step 205 of the process 200 can be expressed as an ordered list of n points c₁, c₂, . . . , cₙ. Each of the points includes both an x coordinate and a y coordinate, so the extracted contour can be represented as a vector of coordinates ((c₁ₓ, c_{1y}), (c₂ₓ, c_{2y}), . . . , (cₙₓ, c_{ny})).

The contour extraction may be implemented at least in part utilizing known techniques such as S. Suzuki and K. Abe, “Topological Structural Analysis of Digitized Binary Images by Border Following,” CVGIP 30 1, pp. 32-46 (1985), and C. H. Teh and R. T. Chin, “On the Detection of Dominant Points on Digital Curve,” PAMI 11 8, pp. 859-872 (1989). Also, algorithms such as the Ramer-Douglas-Peucker (R D P) algorithm can be applied in extracting the contour from the hand ROI.

The particular number of points included in the contour can vary for different types of hand ROI masks. Contour simplification not only conserves computational and storage resources as indicated above, but can also provide enhanced recognition performance. Accordingly, in some embodiments, the number of points in the contour is kept as low as possible while maintaining a shape close to the actual hand ROI.

With reference to FIG. 3, the portion of the figure on the left shows a binary ROI mask with a dot indicating the palm center coordinates (i₀,j₀) of the hand. The portion of the figure on the right illustrates an exemplary contour of the hand ROI after simplification, as determined using the above-noted RDP algorithm. It can be seen that the contour in this example generally characterizes the border of the hand ROI. A contour obtained using the RDP algorithm is also denoted herein as RDG(M).

In applying the RDP algorithm to determine a contour as described above, the degree of coarsening is illustratively altered as a function of distance to the hand. This involves, for example, altering an ε-threshold in the RDP algorithm based on an estimate of mean distance to the hand over the pixels of the hand ROI.

Furthermore, in some embodiments, a given extracted contour is normalized to a predetermined left or right hand configuration. This normalization may involve, for example, flipping the contour points horizontally.

By way of example, the finger detection and tracking module 114 may be configured to operate on either right hand versions or left hand versions. In an arrangement of this type, if it is determined that a given extracted contour or its associated hand ROI is a left hand ROI when the module 114 is configured to process right hand ROIs, then the normalization involves horizontally flipping the points of the extracted contour, such that all of the extracted contours subject to further processing correspond to right hand ROIs. However, it is possible in some embodiments for the module 114 to process both left hand and right hand versions, such that no normalization to a particular left or right hand configuration is needed.

Additional details regarding exemplary left hand and right hand normalizations can be found in Russian Patent Application Attorney Docket No. L13-1279RU1, filed Jan. 22, 2014 and entitled “Image Processor Comprising Gesture Recognition System with Static Hand Pose Recognition Based on Dynamic Warping,” which is commonly assigned herewith and incorporated by reference herein.

After obtaining the contour RDG(M) in the manner described above, the fingertips are located in the following manner. If three successive points of RDG(M) form respective vectors from the palm center (i₀,j₀) with angles between adjacent ones of the vectors being less than a predefined threshold (e.g., 45 degrees) and a central point of these three successive points is further from the palm center (i₀,j₀) than its neighbors, then the central point is considered a fingertip. The pseudocode below provides a more particular example of this approach.

```
  // find fingertip (FT) candidates array
  for (idx=0; idx<handContour.size( ); idx++)
  {
      pdx = idx == 0 ? handContour.size( ) − 1 : idx − 1; // predecessor of
idx
      sdx = idx == handContour.size( ) − 1 ? 0 : idx + 1; // successor of idx
      pdx_vec = handContour[pdx] − (i₀,j₀);
      sdx_vec = handContour[sdx] − (i₀,j₀);
      idx_vec = handContour[idx] − (i₀,j₀);
      // middle point closer to palm center than neighbors
      if ((norm(pdx_vec)<norm(idx_vec)) || (norm(sdx_vec)<norm
      (idx_vec)))
      {
        FTcandidate.push_back(idx);
      }
  }
  for (j=0; j<FTcandidate.size( ); j++)
  {
      int idx = FTcandidate[j];
      pdx = idx == 0 ? handContour.size( ) − 1 : idx − 1; // predecessor of
idx
      sdx = idx == handContour.size( ) − 1 ? 0 : idx + 1; // successor of idx
      Point v1 = handContour[sdx] − handContour[idx];
      Point v2 = handContour[pdx] − handContour[idx];
      float angle = (float)acos( (v1.x*v2.x + v1.y*v2.y) / (norm(v1) *
norm(v2)) );
      float angle_threshold = 1;
      // low interior angle + far enough from center −> we have a finger
      if (angle < angle_threshold && handContour[idx].y < cutoff)
      {
        int u = handContour[idx].x;
        int v = handContour[idx].y;
        fingerTips.push_back(u,v);
      }
    }
```

Referring again to FIG. 3, the right portion of the figure also illustrates the fingertips identified using the above pseudocode technique.

If information regarding number of fingertips and approximate fingertip positions is available from step 201, it may be utilized to supplement the pseudocode technique in the following manner:

1. For each approximate fingertip position provided by step 201 find the closest fingertip position using the above pseudocode. If there is more than one contour point corresponding to the input approximate fingertip position, redundant points are excluded from the set of detected fingertips.

2. If for a given approximate fingertip position provided by step 201 a corresponding contour point is not found, the predefined angle threshold is weakened (e.g., 90 degrees is used instead of 45 degrees) and Step 1 is repeated.

3. If for a given approximate fingertip position provided by step 201 a corresponding contour point is not found within a specified local neighborhood, the number of detected fingertips is decreased accordingly.

4. If the above pseudocode identifies a fingertip which does not correspond to any approximate fingertip position provided by step 201, the number of detected fingertips is increased by one.

Regardless of the availability of information from step 201, the detected number of fingertips and their respective positions are provided to step 207 along with updated palm position. Such output information represents a “correction” of any corresponding information provided as inputs to step 205 from steps 201 and 202.

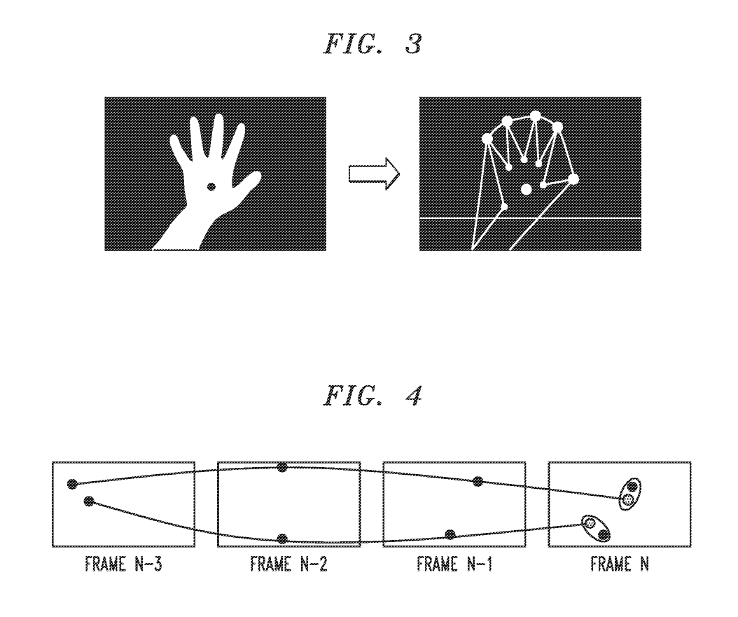

The manner in which detected fingertips are tracked in step 205 will now be described in greater detail, with reference to FIG. 4.

It should initially be noted that if fingertip number and position information is available for each input frame from step 201, it is not necessary to track the fingertip position in step 205. However, it is more typical that such information is available for periodic “keyframes” only (e.g., for every 10^{th} frame on average).

Accordingly, step 205 is assumed to incorporate fingertip tracking over multiple sequential frames. This fingertip tracking generally finds the correspondence between detected fingertips over the multiple sequential frames. By way of example, the fingertip tracking in the present embodiment is performed for a current frame N based on fingertip position trajectories determined using the three previous frames N−1, N−2 and N−3, as illustrated in FIG. 4. More generally, L previous frames may be utilized in the fingertip tracking, where L is also referred to herein as frame history length.

Assuming for illustrative purposes that L=3, the fingertip tracking determines the correspondence between fingertip points in frames N−1 and N−2, and between fingertip points in frames N−2 and N−3. Let (x[i],y[i]), i=1, 2, 3 and 4, denote coordinates of a given fingertip in frames N−3, N−2, N−1 and N, respectively. In order for the fingertip coordinates over the multiple frames to satisfy a quadratic polynomial of the form y[i]=a*x[i]²+b*x[i]+c, for i=1, 2 and 3, coefficients a, b and c are determined as follows:

a=(y[3]−(x[3]*(y[2]−y[1])+x[2*y[1]−x[1]*y[2])/(x[2]−x[1]))/(x[3]*(x[3]−x[2]−x[1])+x[1]*x[2]);

b=(y[2]−y[1])/(x[2]−x[1])−a*(x[1]+x[2]); and

c=a*x[1]*x[2]+(x[2]*y[1]−x[1]*y[2])/(x[2]−x[1]).

A similar fingertip tracking approach can be used with other values of frame history length L. For example, if L=2, a linear polynomial may be used instead of a quadratic polynomial, and if L=1, a polynomial of degree 0 (i.e., a constant) is used. For values of L>3, a parabola that best matches the trajectory (x[i], y[i]) can be determined using least squares or another similar curve fitting technique.

The fingertip trajectories are then extrapolated in the following manner. Let v[i] denote the velocity estimate for the i-th fingertip in the current frame (e.g., v[i]=sqrt((x[i]−x[i−1])²+(y[i]−y[i−1])²). Based on this velocity estimate and the known extrapolation polynomial described previously, the fingertip position in the next frame can be estimated. Examples of fingertip trajectories generated in this manner are illustrated in FIG. 4.

For the current frame there are several estimates (eₓ[k],e_{y}[k]) of fingertip positions, k=1, . . . , K, where K is the total number of estimates (i.e., number of fingertips present in the last L history frames). If Euclidean distance between a current fingertip and estimate (eₓ[k],e_{y}[k]) is minimal throughout all possible estimates, the current fingertip is assumed to correspond to the k-th trajectory. Also, there is a bijection relationship between the k-th trajectory and its associated estimate (eₓ[k],e_{y}[k]).

If for a given fingertip no corresponding point on the contour is found for the current frame, that fingertip is not further considered and may be assumed to “disappear.” Alternatively, the fingertip position can be saved to memory as part of the historical fingertip position data in step 206. For example, the fingertip position can be saved to memory if the fingertip is not found in more than Nmax previous frames, where Nmax≧1. If the number of extrapolations for the current fingertip is greater than Nmax, the fingertip and the corresponding trajectory are removed from the historical fingertip position data.

In the case of one or more conflicts resulting from a given trajectory corresponding to more than one fingertip, fingertips are processed in a predefined order (e.g., from left to right) and fingertips in conflict are each forced to find a new parabola, while minimizing the sum of distances between those fingertips and the new parabolas. If any conflict cannot be resolved in this manner, new parabolas are assigned to the unresolved fingertips, and used in tracking of the fingertips in the next frame.

The historical fingertip position data in step 206 illustratively comprises fingertip coordinates in each of N frames, where N>0 is a positive integer. Coordinates are given by pixel positions (i,j), where frame_width≧i≧0, frame_height≧j≧0. Additional or alternative types of historical fingertip position data can be used in other embodiments. The historical fingertip position data may be configured in the form of what is more generally referred to herein as a “history buffer.”

In step 207, outputs of the fingertip detection and tracking are provided. These outputs illustratively include corrected number of fingertips, fingertip positions and palm position information. Such information can be utilized as estimates for subsequent frames, and thus may provide at least a portion of the information in steps 201 and 202. The information in step 207 can also be utilized by other portions of the recognition subsystem 108, such as one or more of the other recognition modules 115, and is referred to herein as supplementary information resulting from the fingertip detection and tracking.

In step 208, finger skeletons are determined within a given image for respective fingertips detected and tracked in step 205.

By way of example, step 208 is configured in some embodiments to operate on a denoised amplitude image utilizing the fingertip positions determined in step 205. The number of finger skeletons generated corresponds to the number of detected fingertips. A corresponding depth image can also be utilized if available.

The skeletonization operation is performed for each detected fingertip, and illustratively begins with processing of the amplitude image as follows. Starting from a given fingertip position, the operation will iteratively follow one of four possible directions towards the palm center (i₀,j₀). For example, if the palm center is below (j₀<y) fingertip position (x,y), the skeletonization operation proceeds stepwise in a downward direction, considering the (y−m)-th pixel line ((*,y−m) coordinates) at the m-th step.

As indicated previously, in the case of active lighting imagers such as SL or ToF cameras, pixels with lower amplitude values tend to have higher error in their corresponding depth values. Also, the more perpendicular the imaged surface is to the camera view axis, the higher the amplitude value, and therefore the more accurate the corresponding depth value. Accordingly, the skeletonization operation in the present embodiment is configured to determine the brightest point in a given pixel line, which is within a threshold distance from a brightest point in the previous pixel line. More particularly, if (x′,y′) is identified as a skeleton point in a k-th pixel line, the next skeleton point in the next pixel line will be determined as the brightest point among the set of pixels (x′-thr,y′+1), (x′-thr+1,y′+1), . . . (x′+thr,y′+1), where thr denotes a threshold and is illustratively a positive integer (e.g., 2).

A similar approach is utilized when the skeletonization operation moves in one of the three other directions towards the palm center, that is, in an upward direction, a left direction and a right direction.

After an approximate finger skeleton is found using the skeletonization operation described above, outliers can be eliminated by, for example, excluding all points which deviate from a minimal deviated line of the approximate finger skeleton by more than a predefined threshold, e.g., 5 degrees.

If a depth image is also available, and assuming that the depth image and the amplitude image are the same size in pixels, a given skeleton is given by Sk={(x,y,d(x,y))}, where (x,y) denotes pixel position and d(x,y) denotes the depth value in position (x,y). The Sk coordinates may be converted to Cartesian coordinates based on a known camera position. In such an arrangement, Sk[i] denotes a set of Cartesian coordinates of an i-th finger skeleton corresponding to an i-th detected fingertip. Other 3D representations of the Sk coordinates not based on Cartesian coordinates may be used.

It should be noted that a depth image utilized in this skeletonization context and other contexts herein may be generated from a corresponding amplitude image using techniques disclosed in Russian Patent Application Attorney Docket No. L13-1280RU1, filed Feb. 7, 2014 and entitled “Depth Image Generation Utilizing Depth Information Reconstructed from an Amplitude Image,” which is commonly assigned herewith and incorporated by reference herein. Such a depth image is assumed to be masked with the binary ROI mask M and denoised in the manner previously described.

Also, the particular skeletonization operations described above are exemplary only. Other skeletonization operations suitable for determining a hand skeleton in a hand image are disclosed in Russian Patent Application No. 2013148582, filed Oct. 30, 2013 and entitled “Image Processor Comprising Gesture Recognition System with Computationally-Efficient Static Hand Pose Recognition,” which is commonly assigned herewith and incorporated by reference herein. This application further discloses techniques for determining hand main direction for a hand ROI. Such information can be utilized, for example, to facilitate distinguishing left hand and right hand versions of extracted contours.

In step 209, the finger skeletons from step 208 and possibly other related information such as palm position are transformed into specific hand data required by one or more particular applications. For example, in one embodiment, corresponding to the tracking arrangement illustrated in FIG. 4, the recognition subsystem 108 detects two fingertips of a hand and tracks the fingertips through multiple frames, with the two fingertips being used to provide respective fingertip-based cursor pointers on a computer screen or other display. This more particularly involves converting the above-described finger skeletons Sk[i] and associated palm center (i₀,j₀) into the desired fingertip-based cursors. The number of points that are utilized in each finger skeleton Sk[i] is denoted as Np and is determined as a function of average distance between the camera and the finger. For an embodiment with a depth image resolution of 165×120 pixels, the following pseudocode is used to determine Np:

```
if (average distance to finger<0.2)
  Np = 19;//in pixels
else if (average distance to finger <0.25)
  Np = 15;
else if (average distance to finger <0.31)
  Np = 12;
else if (average distance to finger <0.34)
  Np = 8;
else
  Np = 6;
```

After determining the number of points Np, the corresponding portion of the finger skeleton Sk[i][1], . . . Sk[i][Np] is used to reconstruct a line Lk[i] having a minimum deviation from these points, using a least squares technique. This minimum deviation line represents the i-th finger direction and intersects with a predefined imagery plane at a (cₓ[i],c_{y}[i]) point, which represents a corresponding cursor.

The determination of the cursor point (cₓ[i],c_{y}[i]) in the present embodiment illustratively utilizes a rectangular bounding box based on palm center position. It is assumed that the cursor movements for the corresponding finger cannot extend beyond the boundaries of the rectangular bounding box.

The following pseudocode illustrates one example of the calculation of cursor point (cₓ[i],c_{y}[i]), where drawHeight and drawWidth denote linear dimensions of a visible portion of a display screen, and smallWidth and smallHeight denote the dimensions of the rectangular bounding box:

Cₓ *= smallWidth*1.f/drawWidth;
C_{y} *= smallHeight*1.f/drawHeight;
Cₓ += i₀ − smallWidth/2;
C_{y} += j₀ − smallHeight/2;
Cₓ = min(drawWidth−1.f,max(0.f,xx));
C_{y} = min(drawHeight−1.f,max(0.f,yy));

where the notation .f indicates a “float type” constant.

In other embodiments, a dynamic bounding box can be used. For example, based on maximum angles among x and y axes of the display screen between finger directions the dynamic bounding box dimensions are computed as smallWidth=120*|π−α| and smallHeight=100*|π−β|, where α=max((vᵢ,vⱼ)/(|vᵢ|*|vⱼ|)), β=max((wᵢ,wⱼ)/(|wᵢ|*|wⱼ|)), and where vᵢ,wᵢ denote projections of direction vectors of reconstructed lines Lk[i] to x and z axes, respectively, and (vᵢ,vⱼ) denotes a dot product of vectors vᵢ,vⱼ.

The cursors determined in the manner described above can be artificially decelerated as they get closer to edges of the rectangular bounding box. For example, in one embodiment, if (x_{c}[i], y_{c}[i]) are cursor coordinates at frame i, and distances dₓ[i], d_{y}[i] to respective nearest horizontal and vertical bounding box edges are less than predefined thresholds (e.g., 5 and 10), then the cursor is decelerated in the next frame by applying exponential smoothing in accordance with the following equations:

x_{c}[i+1]=(1/dₓ[i])*(x_{c}[i])+(1−1/dₓ[i])*(x_{c}[i+1]);

y_{c}[i+1]=(1/d_{y}[i])*(y_{c}[i])+(1−1/d_{y}[i])*(y_{c}[i+1])

Again, this exponential smoothing operation is applied only when the cursor is within the specified threshold distances of the bounding box edges.

Additional smoothing may be applied in some embodiments, for example, if the amplitude and depth images have low resolutions. As a more particular example, such additional smoothing may be applied after determination of the cursor points, and utilizes predefined constant convergence speeds φ,χ in accordance with the following equations:

x_{c}[i+1]=(1/dₓ[i])*(x_{c}[i])+(1−1/dₓ[i])*(x_{c}[i+1]);

y_{c}[i+1]=(1/d_{y}[i])*(y_{c}[i])+(1−1/d_{y}[i])*(y_{c}[i+1]).

where the convergence speeds φ and χ denote respective real nonnegative values, e.g., φ=0.94 and χ=0.97.

It is to be appreciated that other smoothing techniques can be applied in other embodiments.

Moreover, the particular type of hand data determined in step 209 can be varied in other embodiments to accommodate the specific needs of a given application or set of applications. For example, in other embodiments the hand data may comprise information relating to an entire hand, including fingers and palm, for use in static pose recognition or other types of recognition functions carried out by recognition subsystem 108.

The particular types and arrangements of processing blocks shown in the embodiment of FIG. 2 are exemplary only, and additional or alternative blocks can be used in other embodiments. For example, blocks illustratively shown as being executed serially in the figures can be performed at least in part in parallel with one or more other blocks or in other pipelined configurations in other embodiments.

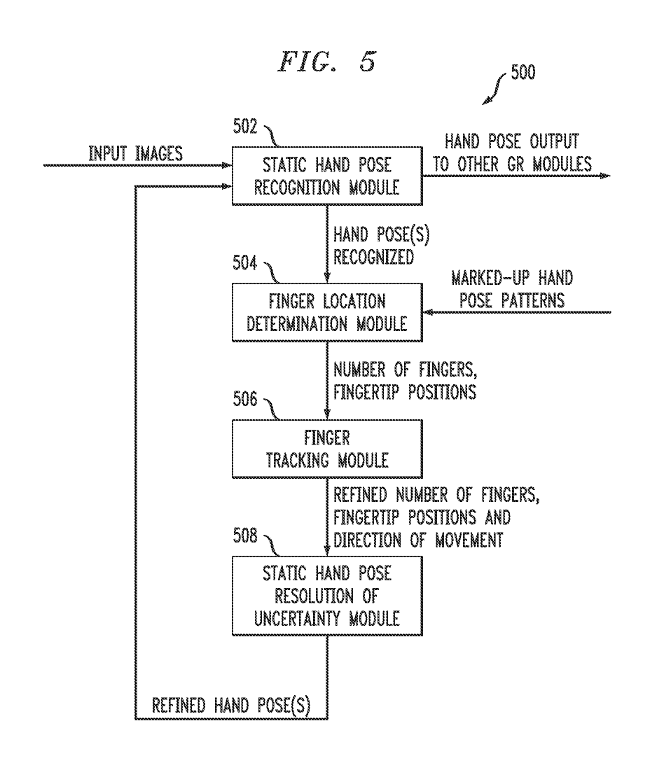

FIG. 5 illustrates another embodiment of at least a portion of the recognition subsystem 108 of image processor 102. In this embodiment, a portion 500 of the recognition subsystem 108 comprises a static hand pose recognition module 502, a finger location determination module 504, a finger tracking module 506, and a static hand pose resolution of uncertainty module.

Exemplary implementations of the static hand pose recognition module 502 suitable for use in the FIG. 5 embodiment are described in the above-cited Russian Patent Application No. 2013148582 and Russian Patent Application Attorney Docket No. L13-1279RU1. The latter reference discloses a dynamic warping approach.

In the FIG. 5 embodiment, the static hand pose recognition module 502 operates on input images and provides hand pose output to other GR modules. The module 502 and the other GR modules that receive the hand pose output represent respective ones of the other recognition modules 115 of the recognition subsystem 108. The static hand pose recognition module 502 also provides one or more recognized hand poses to the finger location determination module 504 as indicated.

The finger location determination module 504, the finger tracking module 506 and the static hand pose uncertainty resolution module 508 are illustratively implemented as sub-modules of the finger detection and tracking module 114 of the recognition subsystem 108. The finger location determination module 504 receives the one or more recognized hand poses from the static hand pose recognition module 502 and marked up hand pose patterns from other components of the recognition subsystem 108, and provides information such as number of fingers and fingertip positions to the finger tracking module 506. The finger tracking module 506 refines the number of fingers and fingertip positions, determines fingertip direction of movement over multiple frames, and provides the resulting information to the static hand pose resolution of uncertainty module 508, which generates refined hand pose information for delivery back to the static hand pose recognition module 502.

The FIG. 5 embodiment is an example of an arrangement in which a finger detection and tracking module receives hand pose recognition input from a static hand pose recognition module and provides refined hand pose information back to the static hand pose recognition module so as to improve the overall static hand pose recognition process. The hand pose recognition input is utilized by the finger detection and tracking module to improve the quality of finger detection and finger trajectory determination and tracking over multiple input frames. The finger detection and tracking module can also correct errors made by the static hand pose recognition module as well as determine hand poses for input frames in which the static hand pose recognition module was not able to definitively recognize any particular hand pose.

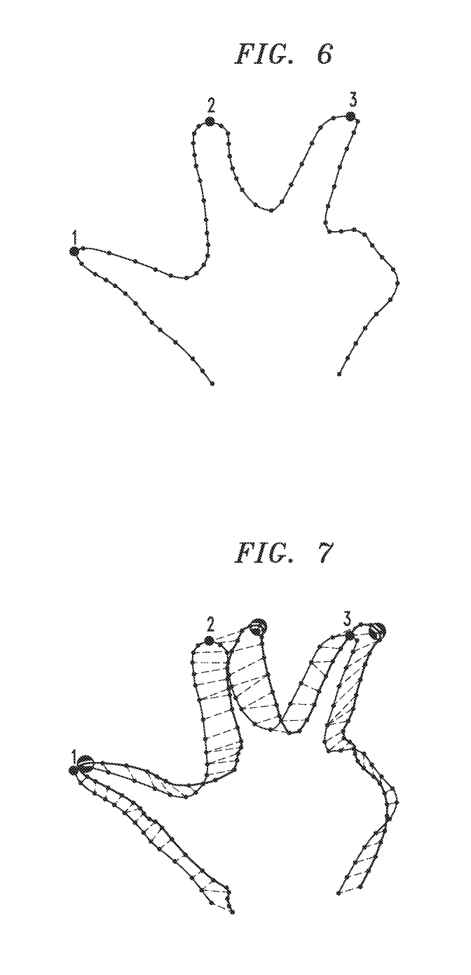

The finger location determination module 504 is illustratively configured in the following manner. For each static hand pose from the GR system vocabulary, a mean or otherwise “ideal” contour of the hand is stored in memory as a corresponding hand pose pattern. Additionally, particular points of the hand pose pattern are manually marked to show actual fingertip positions. An example of a resulting marked-up hand pose pattern is shown in FIG. 6. In this example, the static hand pose is associated with a thumb and two finger gesture, with the respective actual fingertip positions denoted as 1, 2 and 3. The marked-up hand pose pattern can also indicate the particular finger associated with each fingertip position. Thus, in the case of the FIG. 6 example, the marked-up hand pose pattern can indicate that fingertip positions 1, 2 and 3 are associated with the thumb, index finger and middle finger, respectively.

Accordingly, when the static hand pose recognition module 502 indicates a particular recognized hand pose to the finger location determination module 504, the latter module can retrieve from memory the corresponding marked-up hand pose pattern which indicates the ideal contour and the fingertip positions of that contour. It should be noted that other types and formats of hand pose patterns can be used, and terms such as “marked-up hand pose pattern” are intended to be broadly construed.

The finger location determination module 504 then applies a dynamic warping operation of the type disclosed in the above-cited Russian Patent Application Attorney Docket No. L13-1279RU1. The dynamic warping operation is illustratively configured to determine the correspondence between a contour determined from a current frame and a contour of a given marked-up hand pose pattern. For example, the dynamic warping operation can calculate an optimal match between two given sequences of contour points subject to certain restrictions. The sequences are “warped” in contour point index to determine a measure of their similarity and a point-to-point correspondence between the two contours. Such an operation allows the determination of fingertip points in the contour of the current frame by establishing correspondence to respective fingertip points in the given marked-up hand pose pattern.

The application of a dynamic warping operation to determine point-to-point correspondence between the FIG. 6 hand pose pattern contour and another contour obtained from an input frame is illustrated in FIG. 7. It can be seen that the dynamic warping operation establishes correspondence between each of the points on one of the contours and one or more points on the other contour. Corresponding points on the two contours are connected to one another in the figure with dashed lines. A single point on one of the contours can correspond to multiple points on the other contour. The points on the contour from the input frame that are determined to correspond to the fingertip positions 1, 2 and 3 in the FIG. 6 hand pose pattern are labeled with large dots in FIG. 7.

The particular number of fingers and the associated fingertip positions as determined by the finger location determination module 504 for the current frame are provided to the finger tracking module 506.

In some implementations of the FIG. 5 embodiment, the static hand pose recognition module 502 provides multiple alternative hand poses to the finger location determination module 504 for the current frame. For such implementations, the finger location determination module 504 is configured to iterate through each of the alternative poses using the above-described dynamic warping approach. The resulting number of fingertips and fingertip positions for each of the alternative hand poses are then provided by the finger location determination module 504 to the finger tracking module 506.

The finger tracking module 506 can be configured to refine the fingertip position for each of the alternative hand poses. Such information can be provided as corrected information similar to that provided in step 207 of the FIG. 2 embodiment. Additionally or alternatively, one or more of the alternative hand poses can be identified as best matching particular trajectories determined using the above-noted history buffer.

Assuming in the present embodiment that the finger tracking module 506 generates refined information on number of fingers, fingertip positions and direction of movement or trajectory for each of multiple alternative hand poses, the static hand pose resolution of uncertainty module 508 is configured to select a particular one of the hand poses. The module 508 can implement this selection process as follows. For each of the possible alternative hand poses, module 508 determines an affine transform that best matches the fingertip positions in the hand pose pattern to the fingertip positions in the current frame, possibly using a least squares technique, and applies this transform to the current frame contour. Using the point-to-point correspondence between the hand pose pattern contour and the current frame contour, the distance between the two contours is calculated as the square root of the sum of the squared distances between corresponding pattern and affine transformed points of the current contour, and the pose that minimizes the distance between contours is selected. Other distance measures such as sum of distances, maximal value of distances or other similarity measures can be used.

It is to be appreciated that the particular module configuration and other aspects of FIG. 5 embodiment are exemplary only and may be varied in other embodiments. For example, a wide variety of other types of dynamic warping operations can be applied, as will be appreciated by those skilled in the art. The term “dynamic warping operation” as used herein is therefore intended to be broadly construed, and should not be viewed as limited in any way to particular features of the exemplary operations described above.

The above-described illustrative embodiments can provide significantly improved gesture recognition performance relative to conventional arrangements. For example, these embodiments provide computationally efficient techniques for detection and tracking of fingertip positions over multiple frames in a manner that facilitates real-time gesture recognition. The detection and tracking techniques are robust to image noise and can be applied without the need for preliminary denoising. Accordingly, GR system performance is substantially accelerated while ensuring high precision in the recognition process. The disclosed techniques can be applied to a wide range of different GR systems, using images provided by depth imagers, grayscale imagers, color imagers, infrared imagers and other types of image sources, operating with different resolutions and fixed or variable frame rates.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

1. A method comprising steps of:
identifying a hand region of interest in a given image;
extracting a contour of the hand region of interest;
detecting fingertip positions using the extracted contour; and
tracking movement of the fingertip positions over multiple images including the given image;
wherein the steps are implemented in an image processor comprising a processor coupled to a memory.

2. The method of claim 1 wherein the steps are implemented in a finger detection and tracking module of a gesture recognition system of the image processor.

3. The method of claim 1 wherein the extracted contour comprises an ordered list of points.

4. The method of claim 3 wherein detecting fingertip positions comprises:
determining a palm center of the hand region of interest;
identifying sets of multiple successive points of the contour that form respective vectors from the palm center with angles between adjacent ones of the vectors being less than a predetermined threshold; and
if a central point of a given one of the identified sets is further from the palm center than the other points in the set, identifying the central point as a fingertip.

5. The method of claim 1 wherein tracking movement of the fingertip positions comprises determining a trajectory for a set of detected fingertip positions over frames corresponding to respective ones of the multiple images.

6. The method of claim 5 wherein determining a trajectory for the set of detected fingertip positions over the frames comprises determining a trajectory for fingertip positions in a current frame utilizing fingertip positions determined for two or more previous frames.

7. The method of claim 1 wherein identifying a hand region of interest comprises generating a hand image comprising a binary region of interest mask in which pixels within the hand region of interest all have a first binary value and pixels outside the hand region of interest all have a second binary value complementary to the first binary value.

8. The method of claim 1 further comprising:
identifying a palm boundary of the hand region of interest; and
modifying the hand region of interest to exclude from the hand region of interest any pixels below the identified palm boundary.

9. The method of claim 1 further comprising applying a skeletonization operation to the extracted contour to generate finger skeletons for respective fingers corresponding to the detected fingertip positions.

10. The method of claim 9 further comprising:
determining a number of points for each of one or more of the finger skeletons;
utilizing the determined number of points to construct a line for the corresponding finger skeleton;
computing a cursor point from the line.

11. The method of claim 10 wherein computing the cursor point further comprises utilizing a bounding region based on palm center position to limit possible values of the cursor point.

12. The method of claim 10 further comprising applying a deceleration operation to a cursor point in a subsequent frame if a cursor point in a current frame is determined to be within threshold distances of respective edges of a rectangular bounding region.

13. The method of claim 1 further comprising:
receiving hand pose recognition input from a static hand pose recognition module;
processing the received hand pose recognition input to generate one or more refined hand poses for delivery back to the static hand pose recognition module;
wherein the received hand pose information comprises at least one particular identified static hand pose.

14. The method of claim 13 further comprising:
retrieving a stored contour for the particular identified static hand pose;
applying a dynamic warping operation to determine correspondence between points of the stored contour and points of the extracted contour; and
utilizing the determined correspondence to identify fingertip positions in the extracted contour;
wherein the stored contour comprises a marked-up hand pose pattern in which contour points corresponding to fingertip positions are identified.

15. The method of claim 13 wherein processing the received hand pose recognition input comprises:
for each of a plurality of multiple hand poses in the received hand pose recognition input, computing a distance measure between fingertip positions in a hand pose pattern for that hand pose and fingertip positions in a current frame; and
selecting a particular one of the multiple hand poses based on the computed distance measures.

16. (canceled)

17. An apparatus comprising:
an image processor comprising image processing circuitry and an associated memory;
wherein the image processor is configured to implement a gesture recognition system utilizing the image processing circuitry and the memory, the gesture recognition system comprising a finger detection and tracking module; and
wherein the finger detection and tracking module is configured to identify a hand region of interest in a given image, to extract a contour of the hand region of interest, to detect fingertip positions using the extracted contour, and to track movement of the fingertip positions over multiple images including the given image.

18. The apparatus of claim 17 wherein the extracted contour comprises an ordered list of points.

19. (canceled)

20. (canceled)

21. The apparatus of claim 18 wherein the extracted contour includes finger skeletons for respective fingers corresponding to the detected fingertip positions.

22. The apparatus of claim 17 wherein the movement of the fingertip positions over multiple images including the given image movement of the fingertip positions includes a determination of a trajectory for a set of detected fingertip positions over frames corresponding to respective ones of the multiple images.

23. The apparatus of claim 22 wherein the trajectory for the set of detected fingertip positions over the frames includes a trajectory for fingertip positions in a current frame utilizing fingertip positions determined for two or more previous frames.
